(19) United States
(12) Patent Application Publication
(10) Pub. No.: US 2020/0295795 A1
(43) Pub. Date: Sep. 17, 2020

(54) CO-MOLDED MULTI-LAYERED PROTECTIVE CASE FOR MOBILE DEVICE

(71) Applicant: Incipio, LLC, Irvine, CA (US)

(72) Inventor: Andy Fathollahi, Corona del Mar, CA (US)

(73) Assignee: Incipio, LLC, Irvine, CA (US)

(21) Appl. No.: 16/835,290

(22) Filed: Mar. 30, 2020

Related U.S. Application Data
(63) Continuation-in-part of application No. 15/673,277, filed on Aug. 9, 2017.
Application No. 15/673,277 is a continuation of application No. 15/063,464, filed on Mar. 7, 2016, now Pat. No. 9,768,819.
Application No. 15/063,464 is a continuation of application No. 14/585,148, filed on Dec. 29, 2014, now Pat. No. 9,281,858.
(60) Provisional application No. 61/923,631, filed on Jan. 3, 2014.

(51) Int. Cl. H04B 1/3888; A45C 11/00; H04M 1/02

(52) U.S. Cl. CPC H04B 1/3888; A45C 2011/002; H04M 1/0202; A45C 11/00

(57) ABSTRACT

A protective case for a mobile device having a multi-layered construction is disclosed herein. The multi-layered construction includes three layers that are co-molded to one another. The construction is lightweight and low-profile, and also provides a high level of impact protection. The first layer generally forms the external back face surface of the case, the third layer generally forms the perimeter bumper of the case, and the second layer forms the internal liner and includes an elevated pattern of walls upon which the back face of the mobile device rests. The first layer is comprised of material that has a hardness greater than the other two layers. The third layer is comprised of a material that has a hardness that is greater than the hardness of the second layer. The layers are configured to interact with one another to distribute and absorb impact forces.

### CROSS-REFERENCE TO RELATED APPLICATIONS

This application is a continuation-in-part of U.S. patent application Ser. No. 15/673,277, filed on Aug. 9, 2017, which is a continuation of U.S. patent application Ser. No. 15/063,464, filed on Mar. 7, 2016 and issued as U.S. Pat. No. 9,768,819 on Sep. 19, 2017, which is a continuation of U.S. patent application Ser. No. 14/585,148, filed on Dec. 29, 2014 and issued as U.S. Pat. No. 9,281,858 on Mar. 8, 2016, which claims the benefit of and priority to U.S. Provisional Patent Application Ser. No. 61/923,631, filed on Jan. 3, 2014, the entireties of which are hereby incorporated herein by reference.

### BACKGROUND

### Field of the Invention

The present disclosure relates to protective cases for portable electronic devices, and more particularly to such cases that have a unique integrated multi-layered construction.

### Description of the Related Art

Mobile devices, such as smartphones, tablets, laptops, and the like, are known to sustain damage from impact and from contamination as a result of ingress of water or other fluids. The damage, for example, may result in a cracked screen, scratches on a finished surface, lost or damaged buttons or controls, cracked or bent external body components, and/or failed or malfunctioning electrical components. Protective cases are used to protect mobile devices from these and other types of damage.

The bulkiness and weight of protective cases may be an issue for consumers. Thick and heavy protective cases, while capable of providing improved protection to mobile devices, are in tension with the utilitarian qualities, such as light weight and small size, that enhance mobility and attractiveness of mobile devices to consumers. Many users carry their mobile devices in pockets, such as pant pockets. Thus, even a relatively modest increase in bulk or weight may be more noticeable, create user discomfort, and be less desirable.

Accordingly, there is a continuing need to minimize the bulkiness and weight of protective cases for mobile devices while maintaining a high level of protection.

### SUMMARY

A protective case configured to receive, retain, and protect a mobile device is disclosed herein. The protective case includes a front face and a back face that define the height of the mobile device, a perimeter defined by top-end, bottom-end, right, and left sides residing between the front and back faces, and corners defined at the intersecting regions of the sides. The case may be for a mobile device that is in the form of a tablet, a mobile phone, an MP3 audio player, a gaming device, or other portable handheld electronic device and may have one or more touchscreens, including on its front face and/or back face.

The case may be formed of a multilayered construction that includes three layers, various aspects of which are described herein. The first layer is defined by inner and outer surfaces and dimensioned to cover a portion of the back face of the mobile device and/or extend around a portion of the perimeter of the mobile device at the back face boundary. The inner surface of the first layer includes a plurality of protrusions that extend in a direction generally away from the outer surface.

The second layer is defined by inner and outer surfaces and is also dimensioned to cover a portion of the back face of the mobile device and extend around a portion of the perimeter of the mobile device at the back face boundary. The second layer may further include a plurality of corner protrusions positioned along the perimeter region of the second layer to correspond in location with the corners of the mobile device. The second layer may further include an elevated pattern of interconnected walls extending from its inner surface a height above and in a direction away or opposite from the second layer's outer surface. The second layer further includes a plurality of apertures extending into its outer surface that surround (e.g., in close and firm proximity or contact with) one or more of the protrusions of a first group of protrusions of the first layer. The second and/or first layers may each be configured to cover the entire, a majority, half, or less than half of the back face of the mobile device and may be configured to extend around the entire, a majority, half, or less than half of the perimeter of the mobile device at the back face boundary.

The third layer is similarly defined by third inner and outer surfaces and is dimensioned to cover a portion of the top-end, bottom-end, right, and/or left sides of the mobile device. The third layer may include one or more indentations in its inner surface at the corners. The indentations may be in the reverse image of, or otherwise dimensioned to receive, one or more of the corner protrusions of the second layer. The third layer may also include control apertures that are dimensioned and positioned to allow access to control buttons or ports on the mobile device.

The first, second, and third layers may be co-molded to form an integrated construction. The first layer may be made of a first material that has a first hardness, the second layer may be made of a second material that has a second hardness, and the third layer may be made of a third material that has a third hardness. The first hardness is greater than the third hardness, and the third hardness is greater than the second hardness.

For example, the first layer may have a Shore A durometer hardness that is 40% or more greater than the third layer, 30% or more greater than the third layer, 20% or more greater than the third layer, or 10% or more greater than the third layer all ±5% as measured using the American Society for Testing and Materials (ASTM) standard D2240. The second layer may have a Shore A durometer hardness of 45±10, 45±5, or 45 as measured using the American Society for Testing and Materials (ASTM) standard D2240. The third layer may have a Shore A durometer hardness of 65±10, 65±5, or 65 as measured using the American Society for Testing and Materials (ASTM) standard D2240. The third layer may also, for example, have a Shore A durometer hardness that is 40% or more greater than the second layer, 30% or more greater than the second layer, 20% or more greater than the second layer, or 10% or more greater than the second layer all ±5% as measured using the American Society for Testing and Materials (ASTM) standard D2240.

The first, second, and third layers may be formed of a composition comprised of one or more materials including but not limited to polycarbonate (PC), thermoplastic urethane (TPU), thermoplastic elastomer (TPE), acrylonitrile butadiene styrene (ABS), nylon, metal, silicone rubber, or any combination thereof. For example, the first layer, which is the hardest of the three layers, may be formed of a composition comprised of polycarbonate, a combination of polycarbonate and ABS, nylon, fiber-reinforced plastic, and/or metal. The second layer, which is the softest of the three layers, may be formed for example of a composition comprised of TPE, silicone rubber, or combination thereof or other suitable materials. The third layer, which has a hardness between the hardness the other two layers, may be formed for example of a composition that has a relatively high resistance to scratching such as a composition comprised of TPU and/or TPE or a combination thereof or another suitable material.

Thus, in use, when there is an impact at the corners, the third layer, which has a high resistance to scratching and a higher hardness than the second layer, distributes the force of impact and, to the extent the energy of the force is transferred to the second layer, the second layer dampens the shock, especially at the impact prone corners, to thereby mitigate the transfer of the impact energy to the device.

One or more of the plurality of protrusions of the first layer may have a first external shape selected from a group consisting of a square, an octagon, a pentagon, a rectangle, a triangle, a circle, a hexagon, and a heptagon. Also, one or more of the plurality of protrusions may include an aperture residing within the protrusion that defines a first shape selected from a group consisting of a square, an octagon, a pentagon, a rectangle, a triangle, a circle, a hexagon, and a heptagon. Also, the plurality of protrusions in the first layer may be dimensioned to be below, above, or flush with the height of the walls of the second layer that surround the protrusions. Thus, some of the plurality of protrusions in the first layer may be dimensioned to be flush with the height of the interconnected walls in the second layer adjacent thereto, some of the plurality of protrusions may be dimensioned to be below the height of the interconnected walls adjacent thereto, and some of the plurality of protrusions may be dimensioned to be above the height of the interconnected walls adjacent thereto. The plurality of protrusions may be comprised of multiple groups of protrusions with each protrusion in each group being equally or unequally spaced from one another or spaced in a defined pattern. The plurality of protrusions may be comprised of a first group configured to reside closer to the top end or side than the bottom end or side, a second group may be configured to reside closer to the bottom end or side than the top end or side, and a third group may be configured to reside an equal distance from the right and left sides.

The number of corner protrusions in the second layer may be two, three, four, or more (depending on the number of corners on the mobile device), each of which is configured to reside at one, some, or all of the corners of the mobile device or any combination of corners thereof. For example, one corner protrusion may be configured to reside at a corner defined in part by the top side of the mobile device and another corner protrusion may be configured to reside at a corner defined in part by the bottom side. By way of another example, one corner protrusion may be configured to reside at a corner defined in part by the right side of the mobile device and another corner protrusion may be configured to reside at a corner defined in part by the left side of the mobile device. By way of yet another example, a first corner protrusion may be configured to reside at a corner defined in part by the top side of the mobile device (e.g., the intersection between the top side and the right or left side), a second corner protrusion may be configured to reside at a corner defined in part by the bottom side (e.g., the intersection between the bottom side and the right or left side), a third corner protrusion may be configured to reside at a corner defined in part by the right side (e.g., the intersection between the right side and the top or bottom side), and a fourth corner protrusion may be configured to reside at a corner defined in part by the left side (e.g., the intersection between the left side and the top or bottom side). Correspondingly dimensioned corner indentations in the inner surface of the third layer may be provided to engagingly surround or receive one, some, or all of the corner protrusions. Thus, some or all of the surfaces that define the indentions on the third layer may be in contact with a corresponding corner protrusion on the second layer.

The corner protrusions may be configured or dimensioned to reside above, below, or flush with the height of the mobile device in any combination. For example, one of the corner protrusions may be configured to extend above the height of the mobile device and another of the corner protrusions may be configured to be flush with the height of the mobile device. Alternatively, all of the corner protrusions may be configured to be flush with the height of the mobile device or may be configured to reside below the height of the mobile device. One or all of the corner protrusions may also have uniform or varying dimensions in width and thickness between the base and the apex of the protrusion. For example, the corner protrusions may include a thickness defined between the inner and outer surfaces that varies with the height of the protrusion, such as being thicker (or thinner) at the base of the corner protrusion as compared to the thickness closer to the apex of the corner protrusion. By way of another example, the width generally perpendicular to the thickness may be wider (or narrower) at the base of the corner protrusion as compared to width near the apex of the corner protrusion.

The pattern of elevated interconnected walls of the second layer may be comprised of any arrangement of shapes selected for example from a group consisting of squares, octagons, pentagons, rectangles, triangles, circles, hexagons, heptagons, or a combination thereof. By way of example, the interconnected walls may be comprised of walls that form hexagons or portions thereof, which together create a honeycomb wall pattern. The apertures in the second layer and the plurality of protrusions of the first layer may also be hexagonal in shape and dimensioned to closely or snugly fit or mate together, so that one, some, or all six of the walls that form the mating hexagons are in contact with one another. The pattern of elevated interconnected walls may be contiguous or dis-contiguous, may or may not extend to the perimeter regions of the second layer, may be positioned in discrete regions, or may be spaced apart from one another. Various patterns comprising one or more shapes may be employed alone or in combination with other patterns, such that one region of the inner surface of the second layer may have one pattern and another region of the inner surface of the second layer may have another pattern. The elevated pattern of interconnected walls may be configured in height and construction so as to suspend the back face of the mobile device above the apertures defined by the interconnected walls so that the back face of the mobile device does not bottom-out on (or become in contact with) the recessed inner surface of the second layer. Although not depicted, a pattern of interconnected walls may also be employed on the inner surface of the third layer to create an air-suspension frame around the mobile device at the perimeter and front face regions of the mobile device as well as the one created by the second layer vis-a-vis the back face region.

The second layer may further comprise one or more button protrusions that are dimensioned and configured to extend within one or more of the control apertures of the third layer. Each button protrusion may or may not be co-molded to the perimeter of the control aperture to form an integrated region therewith and may be configured to reside above or over a user control button on the mobile device such as a volume, power, mute, or other user button.

The third layer may also include one or more stability tabs configured to extend underneath the back face of the mobile device. The inner surface of the tab may be in contact with the outer surface of the second layer, while the outer surface of the tab may be exposed externally. The tab may be received within an aperture on the first layer that opens to the perimeter. The aperture may be configured to reside closer to one end of the mobile device than the other end and may be configured to reside closer to one side of the mobile device than the other side. Alternatively the aperture and tab may be configured to be centrally positioned relative to one or more sides of the mobile device.

The third layer may also be configured to include a retention rim positioned to reside over the perimeter region of the front face of the mobile device to retain the mobile device within the case. The retention rim may encircle a portion or the entire front face. For example the retention rim may be configured to extend along the top, bottom, left, or right sides of the mobile device or any combination thereof. For example, the rim may extend only in the corner regions or only in regions other than the corner regions, or in a combination of corner and non-corner regions, which may facilitate insertion and removal of the mobile device from the phone. In this respect, the case is configured and constructed with sufficient flexibility to allow the user to install and remove the mobile device within the case without damaging the case or the mobile device.

The third layer may further comprise one or more button protrusions. Each button protrusion may be configured to reside above or over a user control button on the mobile device such as a volume, power, mute, or other user button. In embodiments where the third layer comprises one or more button protrusions, the second layer preferably will not include button protrusions.

The second layer may include one or more apertures to allow for functionality and so as to facilitate the intended use of the mobile device. For example, the second layer may include a camera lens aperture that extends therethrough and is configured to reside around the outside of a camera lens window on the back face of the mobile device. The walls that define the apertures may extend through the first layer and may overlap the outer surface of the third layer. To the extent there is a touchscreen on the back face or other surface region of the mobile device, the second and first layers may have an aperture to allow user interaction with that touchscreen.

Methods of manufacturing a protective case that includes one or more of the various foregoing aspects are also disclosed. Manufacturing steps may, for example, include:

(1) co-molding three distinct layers within a mold to form an integrated protective case construct;

(2) molding the first layer defined by first inner and outer surfaces and dimensioned to cover at least a portion of the back face of the mobile device and extend around at least a portion of the perimeter of the mobile device at the back face boundary; where the first layer may be molded to include a first plurality of protrusions extending from its inner surface in a direction away from its outer surface; and where the first layer may be molded of a material that is harder than each of the second and third layers;

(3) co-molding, around the perimeter regions of the first layer, the third layer defined by third inner and outer surfaces and dimensioned to cover one or more regions of the top, bottom, right, and left sides of the mobile device; where the third layer may be further molded to include one or more control apertures dimensioned and positioned to allow access to control buttons or ports on the mobile device; and include indentations in its inner surface at regions configured to reside at the corners of the mobile device, where the indentations are dimensioned to surround corner protrusions of the second layer; and where the third layer may be molded of material that is harder than the second layer; and (4) co-molding, onto the inner surface of both the first and third layers, the second layer defined by second inner and outer surfaces and dimensioned to cover at least a portion of the back face of the mobile device and extend around at least a portion of the perimeter of the mobile device at the back face boundary; where the second layer may include a plurality of corner protrusions positioned along the perimeter region of the second layer to correspond in location with corners of the mobile device and dimensioned to extend at, below, or above the height of the mobile device (as measured thereat between the front and back faces); may include a pattern of walls extending from its inner surface a height above and in a direction away from its outer surface that may form any arrangement of shapes selected for example from a group consisting of squares, octagons, pentagons, rectangles, triangles, circles, hexagons, heptagons, or any combination thereof; and may include a plurality of apertures that surround and are in contact with one or more of the protrusions in the first layer.

The various configuration and construction aspects of the three component layers described above or otherwise herein (including as illustrated in the drawings) may be included in the molding process of the layer with any of the foregoing steps, or portions of any of the foregoing steps, in any combination without limitation.

Each of the foregoing and various aspects, together with those set forth in the claims and summarized above or otherwise disclosed herein, including the drawings, may be combined to form claims for a device, apparatus, system, method of manufacture, and/or method of use.

### BRIEF DESCRIPTION OF THE DRAWINGS

The figures provided herewith are intended to illustrate but not to limit the invention. Reference numbers are re-used in the figures to indicate correspondence between referenced elements.

FIGS. 1A-1F are front face, back face, left side, right side, top side, and bottom side views of a protective case for a mobile device with the mobile device received within the case. The mobile device depicted in the illustration is a depiction of an Apple iPhone 5s^{Tm} mobile phone.

FIG. 2A is a front face view of the protective case illustrated in FIGS. 1A-1F without the mobile device therein.

FIG. 2B is a bottom side view of the protective case illustrated in FIG. 2A.

FIGS. 2C-2D are front and back face perspective views, respectively, of the disassembled protective case illustrated in FIG. 2A showing the three component layers of the case. The perspective views are both taken from the left side.

FIG. 3 is a more detailed partial cross-sectional front face view taken along plane A-A of FIG. 2B showing in greater detail the construction of the case at the bottom end region including the corners and sides thereof and the relationship and configuration of the three integrated component layers.

FIG. 4 is a more detailed partial cross-sectional view of the protective case illustrated in FIG. 2A taken along cross-section line B-B showing in greater detail the construction of the case and the relationship and configuration of the three integrated component layers.

FIG. 5 is a more detailed cross-sectional view of the protective case illustrated in FIG. 2A taken along cross-section line C-C showing in greater detail the construction of the case and the relationship and configuration of the three integrated component layers.

FIG. 6 is a more detailed cross-sectional view of the protective case illustrated in FIG. 2A taken along cross-section line D-D showing in greater detail the construction of the case and the relationship and configuration of the three integrated component layers.

Each figure is generally to scale and hence relative dimensions of the various layers can be determined from the drawings.

### DETAILED DESCRIPTION

Disclosed herein are various aspects of a protective case for a mobile device capable of minimizing bulkiness and weight, yet maintain a high level of protection.

A protective case configured to receive, retain, and protect a mobile device is disclosed herein. The protective case includes a front face and a back face that define the height of the mobile device, a perimeter defined by top-end, bottom-end, right, and left sides residing between the front and back faces, and corners defined at the intersecting regions of the sides. The case may be for a mobile device that is in the form of a tablet, a mobile phone, an MP3 audio player, a gaming device, or other portable handheld electronic device and may have one or more touchscreens, including on its front face and/or back face.

The case may be formed of a multilayered construction that includes three layers, various aspects of which are described herein. The first layer is defined by inner and outer surfaces and dimensioned to cover a portion of the back face of the mobile device and/or extend around a portion of the perimeter of the mobile device at the back face boundary. The inner surface of the first layer includes a plurality of protrusions that extend in a direction generally away from the outer surface.

The second layer is defined by inner and outer surfaces and is also dimensioned to cover a portion of the back face of the mobile device and extend around a portion of the perimeter of the mobile device at the back face boundary. The second layer may further include a plurality of corner protrusions positioned along the perimeter region of the second layer to correspond in location with the corners of the mobile device. The second layer may further include an elevated pattern of interconnected walls extending from its inner surface a height above and in a direction away or opposite from the second layer's outer surface. The second layer further includes a plurality of apertures extending into its outer surface that surround (e.g., in close and firm proximity or contact with) one or more of the protrusions of a first group of protrusions of the first layer. The second and/or first layers may each be configured to cover the entire, a majority, half, or less than half of the back face of the mobile device and may be configured to extend around the entire, a majority, half, or less than half of the perimeter of the mobile device at the back face boundary.

The third layer is similarly defined by third inner and outer surfaces and is dimensioned to cover a portion of the top-end, bottom-end, right, and/or left sides of the mobile device. The third layer may include one or more indentations in its inner surface at the corners. The indentations may be in the reverse image of, or otherwise dimensioned to receive, one or more of the corner protrusions of the second layer. The third layer may also include control apertures that are dimensioned and positioned to allow access to control buttons or ports on the mobile device.

The first, second, and third layers may be co-molded to form an integrated construction. The first layer may be made of a first material that has a first hardness, the second layer may be made of a second material that has a second hardness, and the third layer may be made of a third material that has a third hardness. The first hardness is greater than the third hardness, and the third hardness is greater than the second hardness.

For example, the first layer may have a Shore A durometer hardness that is 40% or more greater than the third layer, 30% or more greater than the third layer, 20% or more greater than the third layer, or 10% o r more greater than the third layer all ±5% as measured using the American Society for Testing and Materials (ASTM) standard D2240. The second layer may have a Shore A durometer hardness of 45±10, 45±5, or 45 as measured using the American Society for Testing and Materials (ASTM) standard D2240. The third layer may have a Shore A durometer hardness of 65±10, 65±5, or 65 as measured using the American Society for Testing and Materials (ASTM) standard D2240. The third layer may also, for example, have a Shore A durometer hardness that is 40% or more greater than the second layer, 30% or more greater than the second layer, 20% or more greater than the second layer, or 10% or more greater than the second layer all ±5% as measured using the American Society for Testing and Materials (ASTM) standard D2240.

The first, second, and third layers may be formed of a composition comprised of one or more materials including but not limited to polycarbonate (PC), thermoplastic urethane (TPU), thermoplastic elastomer (TPE), acrylonitrile butadiene styrene (ABS), nylon, metal, silicone rubber, or any combination thereof. For example, the first layer, which is the hardest of the three layers, may be formed of a composition comprised of polycarbonate, a combination of polycarbonate and ABS, nylon, fiber-reinforced plastic, and/or metal. The second layer, which is the softest of the three layers, may be formed for example of a composition comprised of TPE, silicone rubber, or combination thereof or other suitable materials. The third layer, which has a hardness between the hardness the other two layers, may be formed for example of a composition that has a relatively high resistance to scratching such as a composition comprised of TPU and/or TPE or a combination thereof or another suitable material.

Thus, in use, when there is an impact at the corners, the third layer, which has a high resistance to scratching and a higher hardness than the second layer, distributes the force of impact and, to the extent the energy of the force is transferred to the second layer, the second layer dampens the shock, especially at the impact prone corners, to thereby mitigate the transfer of the impact energy to the device.

One or more of the plurality of protrusions of the first layer may have a first external shape selected from a group consisting of a square, an octagon, a pentagon, a rectangle, a triangle, a circle, a hexagon, and a heptagon. Also, one or more of the plurality of protrusions may include an aperture residing within the protrusion that defines a first shape selected from a group consisting of a square, an octagon, a pentagon, a rectangle, a triangle, a circle, a hexagon, and a heptagon. Also, the plurality of protrusions in the first layer may be dimensioned to be below, above, or flush with the height of the walls of the second layer that surround the protrusions. Thus, some of the plurality of protrusions in the first layer may be dimensioned to be flush with the height of the interconnected walls in the second layer adjacent thereto, some of the plurality of protrusions may be dimensioned to be below the height of the interconnected walls adjacent thereto, and some of the plurality of protrusions may be dimensioned to be above the height of the interconnected walls adjacent thereto. The plurality of protrusions may be comprised of multiple groups of protrusions with each protrusion in each group being equally or unequally spaced from one another or spaced in a defined pattern. The plurality of protrusions may be comprised of a first group configured to reside closer to the top end or side than the bottom end or side, a second group may be configured to reside closer to the bottom end or side than the top end or side, and a third group may be configured to reside an equal distance from the right and left sides.

The number of corner protrusions in the second layer may be two, three, four, or more (depending on the number of corners on the mobile device), each of which is configured to reside at one, some, or all of the corners of the mobile device or any combination of corners thereof. For example, one corner protrusion may be configured to reside at a corner defined in part by the top side of the mobile device and another corner protrusion may be configured to reside at a corner defined in part by the bottom side. By way of another example, one corner protrusion may be configured to reside at a corner defined in part by the right side of the mobile device and another corner protrusion may be configured to reside at a corner defined in part by the left side of the mobile device. By way of yet another example, a first corner protrusion may be configured to reside at a corner defined in part by the top side of the mobile device (e.g., the intersection between the top side and the right or left side), a second corner protrusion may be configured to reside at a corner defined in part by the bottom side (e.g., the intersection between the bottom side and the right or left side), a third corner protrusion may be configured to reside at a corner defined in part by the right side (e.g., the intersection between the right side and the top or bottom side), and a fourth corner protrusion may be configured to reside at a corner defined in part by the left side (e.g., the intersection between the left side and the top or bottom side). Correspondingly dimensioned corner indentations in the inner surface of the third layer may be provided to engagingly surround or receive one, some, or all of the corner protrusions. Thus, some or all of the surfaces that define the indentions on the third layer may be in contact with a corresponding corner protrusion on the second layer.

The corner protrusions may be configured or dimensioned to reside above, below, or flush with the height of the mobile device in any combination. For example, one of the corner protrusions may be configured to extend above the height of the mobile device and another of the corner protrusions may be configured to be flush with the height of the mobile device. Alternatively, all of the corner protrusions may be configured to be flush with the height of the mobile device or may be configured to reside below the height of the mobile device. One or all of the corner protrusions may also have uniform or varying dimensions in width and thickness between the base and the apex of the protrusion. For example, the corner protrusions may include a thickness defined between the inner and outer surfaces that varies with the height of the protrusion, such as being thicker (or thinner) at the base of the corner protrusion as compared to the thickness closer to the apex of the corner protrusion. By way of another example, the width generally perpendicular to the thickness may be wider (or narrower) at the base of the corner protrusion as compared to width near the apex of the corner protrusion.

The pattern of elevated interconnected walls of the second layer may be comprised of any arrangement of shapes selected for example from a group consisting of squares, octagons, pentagons, rectangles, triangles, circles, hexagons, heptagons, or a combination thereof. By way of example, the interconnected walls may be comprised of walls that form hexagons or portions thereof, which together create a honeycomb wall pattern. The apertures in the second layer and the plurality of protrusions of the first layer may also be hexagonal in shape and dimensioned to closely or snugly fit or mate together, so that one, some, or all six of the walls that form the mating hexagons are in contact with one another. The pattern of elevated interconnected walls may be contiguous or dis-contiguous, may or may not extend to the perimeter regions of the second layer, may be positioned in discrete regions, or may be spaced apart from one another. Various patterns comprising one or more shapes may be employed alone or in combination with other patterns, such that one region of the inner surface of the second layer may have one pattern and another region of the inner surface of the second layer may have another pattern. The elevated pattern of interconnected walls may be configured in height and construction so as to suspend the back face of the mobile device above the apertures defined by the interconnected walls so that the back face of the mobile device does not bottom-out on (or become in contact with) the recessed inner surface of the second layer. Although not depicted, a pattern of interconnected walls may also be employed on the inner surface of the third layer to create an air-suspension frame around the mobile device at the perimeter and front face regions of the mobile device as well as the one created by the second layer vis-a-vis the back face region.

The second layer may further comprise one or more button protrusions that are dimensioned and configured to extend within one or more of the control apertures of the third layer. Each button protrusion may or may not be co-molded to the perimeter of the control aperture to form an integrated region therewith and may be configured to reside above or over a user control button on the mobile device such as a volume, power, mute, or other user button.

The third layer may also include one or more stability tabs configured to extend underneath the back face of the mobile device. The inner surface of the tab may be in contact with the outer surface of the second layer, while the outer surface of the tab may be exposed externally. The tab may be received within an aperture on the first layer that opens to the perimeter. The aperture may be configured to reside closer to one end of the mobile device than the other end and may be configured to reside closer to one side of the mobile device than the other side. Alternatively the aperture and tab may be configured to be centrally positioned relative to one or more sides of the mobile device.

The third layer may also be configured to include a retention rim positioned to reside over the perimeter region of the front face of the mobile device to retain the mobile device within the case. The retention rim may encircle a portion or the entire front face. For example the retention rim may be configured to extend along the top, bottom, left, or right sides of the mobile device or any combination thereof. For example, the rim may extend only in the corner regions or only in regions other than the corner regions, or in a combination of corner and non-corner regions, which may facilitate insertion and removal of the mobile device from the phone. In this respect, the case is configured and constructed with sufficient flexibility to allow the user to install and remove the mobile device within the case without damaging the case or the mobile device.

The third layer may further comprise one or more button protrusions. Each button protrusion may be configured to reside above or over a user control button on the mobile device such as a volume, power, mute, or other user button. In embodiments where the third layer comprises one or more button protrusions, the second layer preferably will not include button protrusions.

The second layer may include one or more apertures to allow for functionality and so as to facilitate the intended use of the mobile device. For example, the second layer may include a camera lens aperture that extends therethrough and is configured to reside around the outside of a camera lens window on the back face of the mobile device. The walls that define the apertures may extend through the first layer and may overlap the outer surface of the third layer. To the extent there is a touchscreen on the back face or other surface region of the mobile device, the second and first layers may have an aperture to allow user interaction with that touchscreen.

Methods of manufacturing a protective case that includes one or more of the various foregoing aspects are also disclosed. Manufacturing steps may, for example, include:
(1) co-molding three distinct layers within a mold to form an integrated protective case construct;
(2) molding the first layer defined by first inner and outer surfaces and dimensioned to cover at least a portion of the back face of the mobile device and extend around at least a portion of the perimeter of the mobile device at the back face boundary; where the first layer may be molded to include a first plurality of protrusions extending from its inner surface in a direction away from its outer surface; and where the first layer may be molded of a material that is harder than each of the second and third layers;
(3) co-molding, around the perimeter regions of the first layer, the third layer defined by third inner and outer surfaces and dimensioned to cover one or more regions of the top, bottom, right, and left sides of the mobile device; where the third layer may be further molded to include one or more control apertures dimensioned and positioned to allow access to control buttons or ports on the mobile device; and include indentations in its inner surface at regions configured to reside at the corners of the mobile device, where the indentations are dimensioned to surround corner protrusions of the second layer; and where the third layer may be molded of material that is harder than the second layer; and
(4) co-molding, onto the inner surface of both the first and third layers, the second layer defined by second inner and outer surfaces and dimensioned to cover at least a portion of the back face of the mobile device and extend around at least a portion of the perimeter of the mobile device at the back face boundary; where the second layer may include a plurality of corner protrusions positioned along the perimeter region of the second layer to correspond in location with corners of the mobile device and dimensioned to extend at, below, or above the height of the mobile device (as measured thereat between the front and back faces); may include a pattern of walls extending from its inner surface a height above and in a direction away from its outer surface that may form any arrangement of shapes selected for example from a group consisting of squares, octagons, pentagons, rectangles, triangles, circles, hexagons, heptagons, or any combination thereof; and may include a plurality of apertures that surround and are in contact with one or more of the protrusions in the first layer.

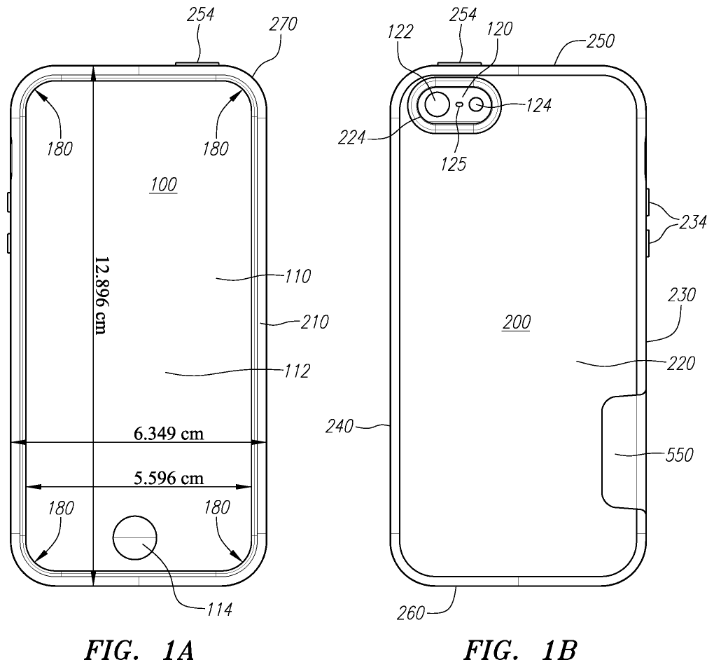

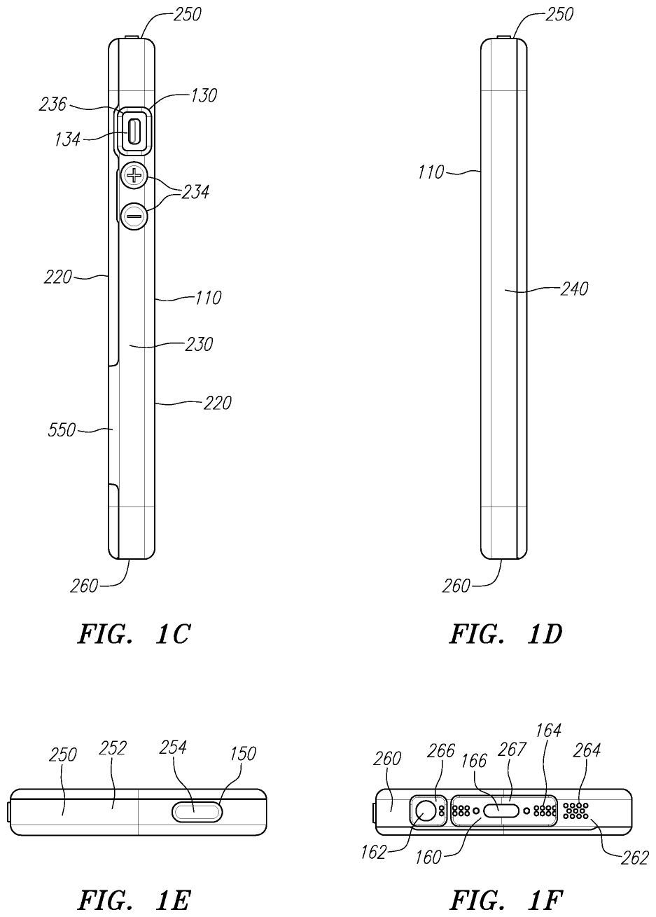

Commonly disclosed in FIGS. 1-6 is a protective enclosure or case 200 for a mobile device 100 that illustrates, by way of example, various configuration and construction aspects of the case. In this particular embodiment, the case is configured for an Apple iPhone 5s™ mobile or smartphone device. It should be understood, however, that the case may be configured for any mobile device or electronic device, including but not limited to portable or cellular phones, PDAs, gaming devices, laptop computers, or tablet devices.

As best depicted in FIGS. 1A-1F, the mobile device 100 includes front 110 and back 120 faces, and a left side 130, a right side 140 (hidden from view), a top side 150, and a bottom side 160 that together define the perimeter 170 of the mobile device 100. The front and back faces are flat and the sides have flat surfaces that extend between the front 110 and back 120 faces and the distance between the front 110 and back 120 faces define the height of the device 100. Corner regions 180 are defined at the curved regions where the sides intersect with one another. The front face 110 includes a touchscreen 112 user interface, a home button 114 with biometric sensor (surrounding the home button), speakers, a front facing camera, and proximity sensors 116, 117, and 118 (located at the top end region on the front face of the phone) that are not shown in the illustrations, but well known to one of ordinary skill in the art. The back face 120 includes a camera lens window 122, a flash 124, and a microphone 125 that are grouped together in the upper corner on the right side of the device 100. The left side 130 includes volume control buttons 132 (hidden below the corresponding case + and − buttons) and ringer silent switch 134 that controls whether the phone is on silent mode. The top side 150 includes a depressible power button 152 (also hidden behind the corresponding power button 254 on the case). The bottom side 160 includes a headphone jack 162, microphone grill 164, and a data and charging port 166.

Generally, the protective case 200 includes front 210 and back 220 face walls and left side 230 and right side 240 walls and top side 250 and bottom side 260 walls. The side walls, 230, 240, 250, and 260 reside between the front and back faces. Each of the walls 210, 220, 230, 240, 250, and 260 are dimensioned to correspond in dimension to the front and back faces, and left, right, top, and bottom sides 110, 120, 130, 140, 150, and 160 of the mobile device 100, respectively.

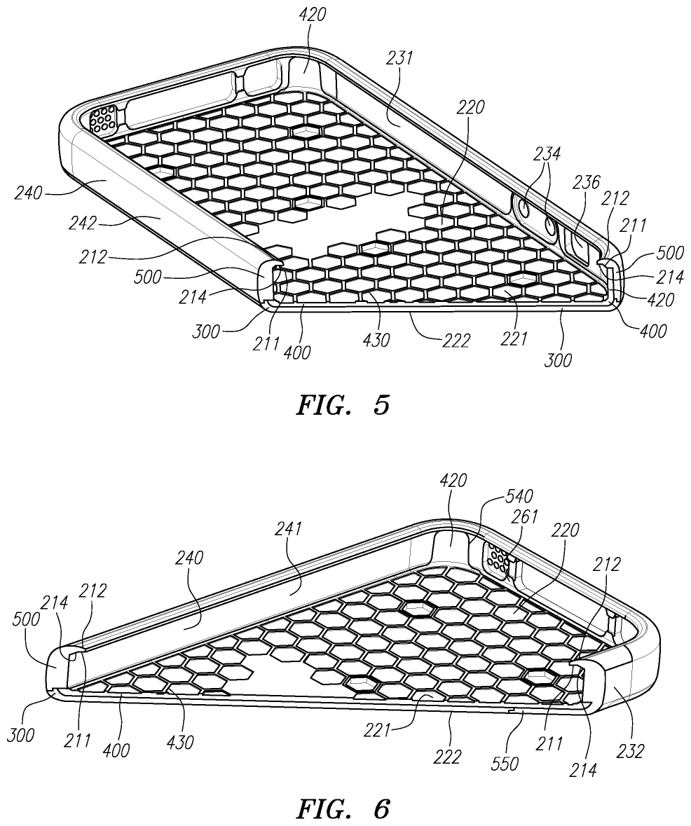

More specifically, the front face wall 210 is defined by inner 211 and outer 212 surfaces and includes an inwardly projecting rim 214 (best illustrated in the cross-sectional views of FIGS. 5 and 6). The back face wall 220 is also defined by inner 221 and outer 222 surfaces and includes a camera lens and flash opening or aperture 224 extending therethrough.

The left side 230 and right side 240 walls are also each defined by inner and outer surfaces 231 and 232 and 241 and 242, respectively. The left side wall 230 further includes volume control buttons 234 that are positioned, dimensioned, configured, and adapted to interface and actuate the volume control buttons 132 on the mobile device 100. Also included in the left side wall 230 is an opening or aperture 236 that is positioned and dimensioned to correspond with the ringer silent switch 134 of the mobile device 100 to provide functional user access to the switch 134. The right side wall 240 does not include any apertures or control buttons as none are provided on the Apple iPhone 5s mobile device for which the illustrated case is configured to protect. However, the right side wall may, in alternate embodiments, include either apertures and/or buttons to provide access to or control over corresponding ports or buttons on the mobile device in embodiments where the device has controls or ports on that side. It should be understood, however, that the number of apertures may vary (increase or decrease) and their placement may vary to correspond with controls on the mobile device.

The top side 250 and bottom side 260 walls are also each defined by inner and outer surfaces 251 and 252 and 261 and 262 respectively. The top side wall 250 includes a mobile device power button 254 positioned, dimensioned, configured, and adapted to interface with the power button 152 on the mobile device 100. In the embodiment illustrated, the button 254 resides within an aperture 255 and is connected thereto. For example, the button 254 may be connected in a levered manner 256 to top side wall 250 at one end or at a mid-section of the aperture 255, such that when pressed, the button 254 hinges around the lever connection. The bottom side wall 260 includes perforated regions 264 positioned and dimensioned to correspond with the microphone grill 164 regions on the mobile device 100. The bottom side wall 260 further includes a headphone jack 266 and data/charging port apertures 267 that are positioned and dimensioned to correspond with the headphone jack port 162 and the data and charging port 166, respectively. Collectively the side walls 230, 240, 250, and 260 define a perimeter 270 between the front and back faces 210 and 220 of the protective case 200.

The case 200 is formed of a multilayered construction that includes three layers 300, 400, and 500 that are co-molded together to form a unitary integral construct. Various aspects of these layers and their inter-relationship, construction, and manufacture are described in more detail below.

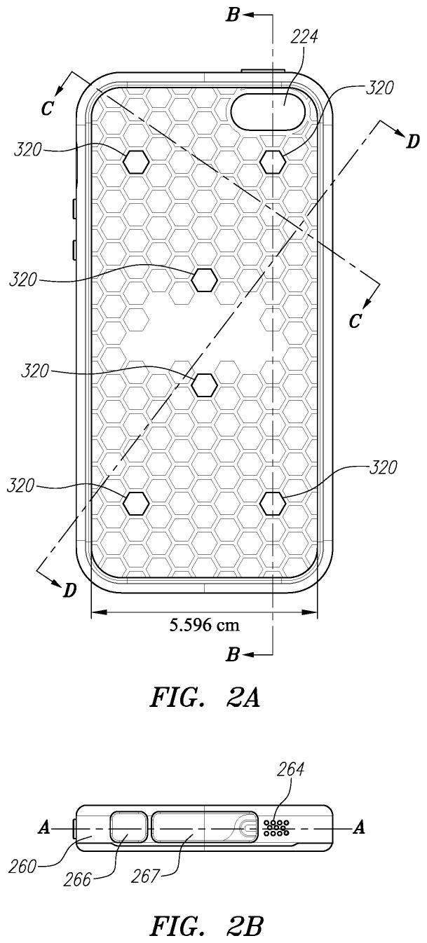

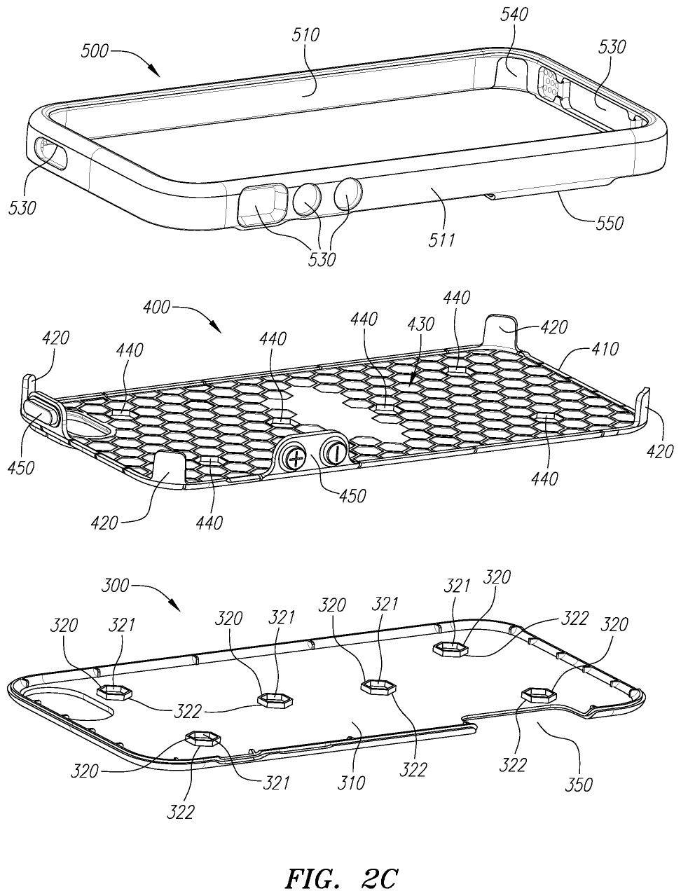

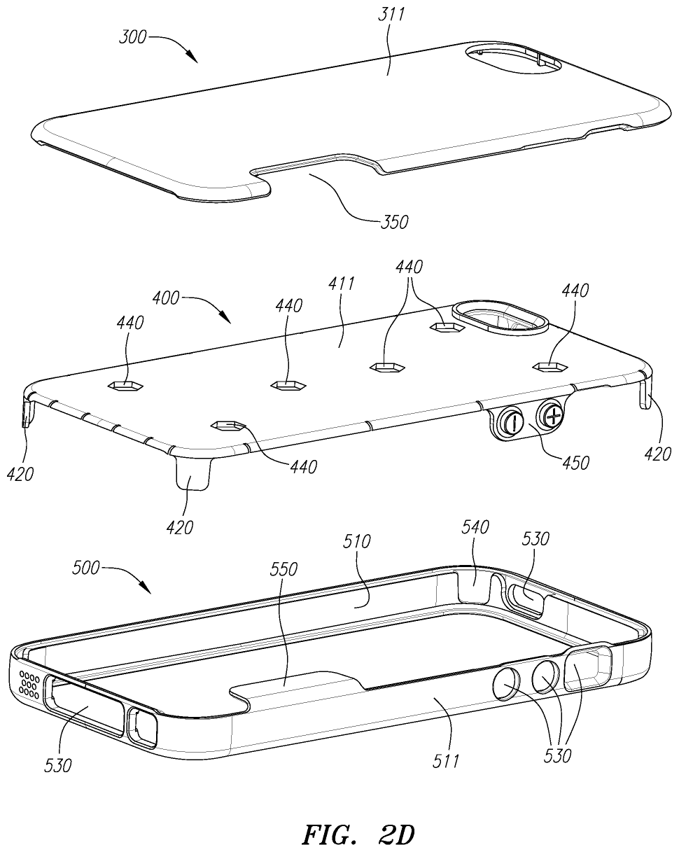

As best illustrated in FIGS. 2C-2D, the first layer 300 is defined by first inner 310 and outer 311 surfaces, and is dimensioned to cover the back face 120 of the mobile device 100. The first layer 300 is configured to extend to the perimeter 170 of the mobile device 100 at the back face 120 boundary, which is the perimeter defined by the intersection of the side walls 130, 140, 150, and 160 and the back face 120 of the mobile device 100. The first inner surface 310 includes a first plurality of protrusions 320 (best illustrated in FIGS. 2A and 2C) extending generally in a direction away from the outer surface 311 of the first layer 300.

The second layer 400 is defined by second inner 410 and outer 411 surfaces, and is also dimensioned to cover the back face 120 of the mobile device and extend around the perimeter 170 of the mobile device 100 at the back face 120 boundary. The second layer 400 further includes a plurality of corner protrusions 420 positioned along the perimeter region of the second layer 400 to correspond in location with the corners 180 of the mobile device 100. The corner protrusions 420 are dimensioned to reside at a height that is slightly below the height of the mobile device 100 at the corners 180. However, in alternate embodiments, one, some, or all of the corner protrusions 420 may extend at, below, or above the height of the mobile device 100 in any combination. The second layer 400 may further include an elevated pattern of interconnected walls 430 extending from the second inner surface 410 a height above and in a direction away from the second outer surface 411. Also included in the second layer 400 is a plurality of apertures 440 extending into the second outer surface 411, such that one or more of the apertures 440 are dimensioned and positioned to surround (e.g., in close proximity and firm contact) one or more of the protrusions 320 of the first layer 300.

The first 300 and second 400 layers may be configured to cover the entire, a majority, half, or less than half of the back face 120 of the mobile device 100 and may be configured to extend to or around the entire, a majority, half, or less than half of the perimeter 170 of the mobile device 100 at the back face 120 boundary.

In the illustrated embodiment, the first layer 300 is configured to cover nearly the entire back face 120 of the mobile device 100, with the exception of the flash and camera lens window aperture 224 and nearly the entire perimeter 170 of the back face 120 with the exception of the tab aperture 350, described in more detail below. It should be understood however, that alternative configurations may be employed. For example, interposed or intervening regions, such as those between the protrusions 320 and/or apertures 440, may be removed from the first 300 and/or second 400 layers while perimeter regions of the first 300 and/or second 400 layers may be maintained. Perimeter regions in the first 300 and/or second 400 layers that reside between one or more of the corners may be removed. Mid-section regions of the layers 300 and 400 may be removed to allow for access to, or user utilization of, user controls, additional touchscreen interface, and/or other device features (e.g., speakers, cameras, lights, microphone, etc.) that are located on the side walls 130, 140, 150, and 160 and/or back face 120 of the mobile device 100.

Additionally, while the pattern of walls 430 in the second layer 400 is illustrated as being interconnected and elevated, it should be understood that the walls may be disconnected at one or more locations or in discrete regions. Also, while the pattern of walls 430 are illustrated as having a generally uniform height or elevation, it should be understood that the walls 430 may have differing heights at discrete regions within the pattern or within or at specific walls or wall segments within the pattern of walls 430.

The third layer 500 is also defined by third inner 510 and outer 511 surfaces. The third layer 500 is generally dimensioned to cover the left 130, right 140, top 150 and/or bottom 160 sides of the mobile device 100 and forms the inwardly projecting rim 214 of the front face wall 210. While in the illustrated embodiment the third layer 500 extends around the entire perimeter of the mobile device 100, it may be configured in other ways. Thus it should be understood that the third layer 500 may cover the entire, a majority, half, or less than half of the top, bottom, right and/or left sides of the mobile device 100 and/or may be configured to extend around less than the entire, a majority, half, or less than half of the perimeter 170 of the mobile device 100 in any combination. Thus, for example the third layer may cover the corners of the mobile device alone or may cover the corners of the mobile device with and only a portion of one or more of the sides extending therebetween. The third layer 500 includes one or more mobile device 100 control apertures 530 that extend through the layer that are dimensioned and positioned to allow access (or flow through with respect to speakers and the like) to control buttons or ports (e.g., power button 152, volume button 132, ringer silent switch 134, headphone jack 162, microphone grill 164, and data/charging port 166) on the mobile device 100. However, it should be understood that, in alternate embodiments, the third layer may instead include button protrusions in place of one or more of the apertures. The third layer also further includes one or more indentations 540 in the third inner surface 510 at regions configured to reside at the corners 180 of the mobile device 100. The indentations 540 are configured to be in the negative image of the corner protrusions or otherwise dimensioned to receive one or more of the plurality of corner protrusions 420 of the second layer 400.

While, the first 300, second 400, and third 500 layers may be co-molded to form an integrated construction, it should be understood that it is contemplated that only portions of one or more of the layers may be co-molded, or each of the layers may be separately formed and mechanically attached to one another by clips, snaps, or latches between each of the components or between, for example, the third layer and the first layer. A combination of co-molding and mechanical attachment of the layers or portions thereof may also be employed. In a fully integrated or co-molded construction the case 200 would be properly dimensioned and have sufficient flexibility to allow the user to insert and remove the mobile device 100 without damage to the case 200. When the components are modular or separable from one another, the user may wrap the second layer around the mobile device 100 and then clip the first and third layers in position around the device 100. The clips, snaps, or hooks or other mechanical attachments may be formed or molded into: (a) two or more of the layers at their perimeter regions, (b) the protrusions 320 and apertures 440 of the first 300 and second 400 layers, (c) one or more of the corner protrusions 420 and indentions 540 in the second 400 and third 500 layers, (d) the control buttons 234 and corresponding apertures 530 on the second 400 and third 500 layers, and/or (e) at any region where two or more layers are in contact or proximity to one another. Thus, a combination of co-molding and/or mechanical attachment of the layers may be employed. Alternatively or in addition, one or more of the layers may be adhesively attached or otherwise bonded to one another.

The materials that form the layers may be selected based on their hardness. For example, the first layer 300 may be made of a first material that has a first hardness, the second layer 400 may be made of a second material that has a second hardness that is different from the first layer, and the third layer 500 may be made of a third material that has a third hardness that is different from the first or second hardness. In a preferred embodiment, the first hardness is greater than the third hardness and the third hardness is greater than the second hardness.

In the illustrated embodiment the protrusions 320 have a hexagonal external and internal shape. However, it should be understood that other shapes may be employed. For example, one or more or all of the plurality of protrusions 320 of the first layer 300 may have a first external shape selected from a group consisting of a square, an octagon, a pentagon, a rectangle, a triangle, a circle, a hexagon, and a heptagon. One or more or all of the plurality of protrusions 320 may each include an aperture 321 residing therein that defines an internal shape selected from a group consisting of a square, an octagon, a pentagon, a rectangle, a triangle, a circle, a hexagon, and a heptagon. One or more or all of the plurality of protrusions 320 may be dimensioned so that the upper surface 322 is below, above, or flush with the upper surface 422 height of the interconnected walls 430 of the second layer 400 surrounding the protrusions 320 of the first layer 300. Thus, some or none of the plurality of protrusions 320 may be dimensioned to be flush with the height of the interconnected walls 430 adjacent thereto (as shown in the drawings), some or none of the plurality of protrusions 320 may be dimensioned to be below the height of the interconnected walls 430 adjacent thereto, or some or none of the plurality of protrusions 320 may be dimensioned to be above the height of the interconnected walls 430 adjacent thereto. The plurality of protrusions 320 may be comprised of multiple groups of protrusions with each protrusion 320 in each group being equally spaced from one another. The plurality of protrusions may be comprised of a first group configured to reside closer to the top end side 250 than the bottom end side 260, a second group may be configured to reside closer to the bottom end side 260 than the top-end side 250, and a third group may be configured to reside an equal distance from the right 240 and left 230 sides. One or more protrusions may be positioned in each corner region, the mid region and/or closer to the perimeter than the middle of the case.

The number of corner protrusions 420 in the second layer 400 may be selected from a group consisting of two, three, and four (or more if mobile device has more than four) configured to reside at one, some, or all of the corners 180 of the mobile device 100 or any combination of corners thereof. For example, one corner protrusion 420 may be configured to reside at a corner 180 defined in part by the top side 150 of the mobile device 100 and another corner protrusion 420 may be configured to reside at a corner defined in part by the bottom side 160. By way of another example, one corner protrusion 420 may be configured to reside at a corner 180 defined in part by the right side 140 of the mobile device 100 and another corner protrusion 420 may be configured to reside at a corner 180 defined in part by the left side 130 of the mobile device 100. By way of yet another example, a first corner protrusion 420 may be configured to reside at a corner 180 defined in part by the top side 150 of the mobile device 100, a second corner protrusion 420 may be configured to reside at a corner 180 defined in part by the bottom side 160, a third corner protrusion 420 may be configured to reside at a corner 180 defined in part by the right side 140, and a fourth corner protrusion 420 may be configured to reside at a corner 180 defined in part by the left side 130. Corresponding dimensioned corner indentations 540 in the third layer 500 may be provided to engagingly receive one, some, or all of the corner protrusions 420. Thus, some or all of the surfaces that define the indentions on the third layer may be in contact with corresponding surfaces of the corner protrusions 420 on the second layer 400. In this respect, the corner indentations 540 may be configured to have a reverse image of the desired shape of the corner protrusions 420.

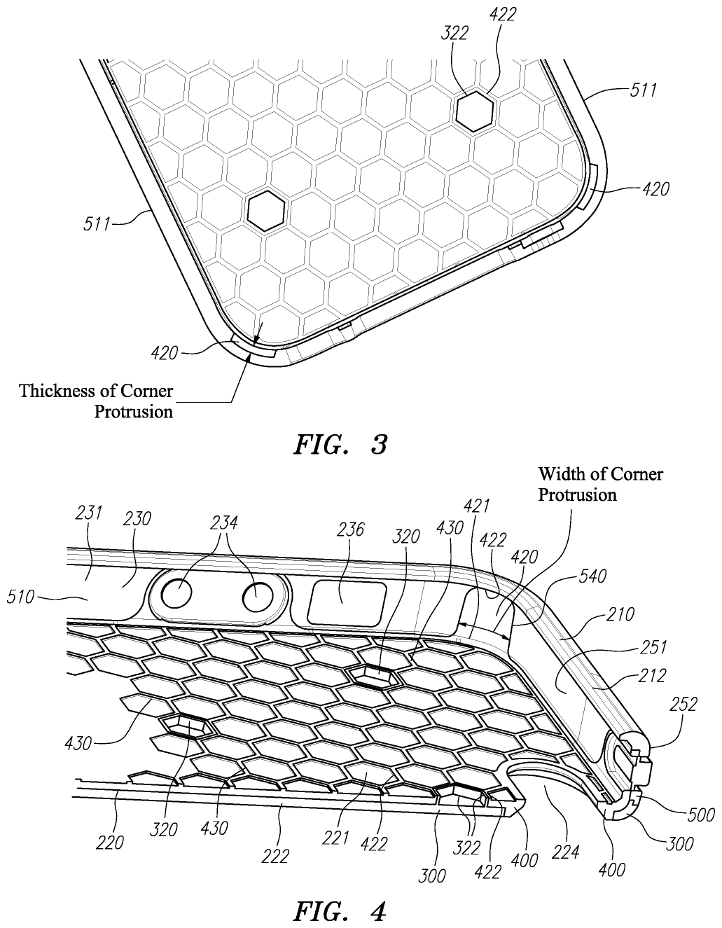

The corner protrusions 420 may be configured or otherwise dimensioned to reside above, below, or flush with the height of the mobile device 100, in any combination. For example, one of the corner protrusions 420 may be configured to extend above the height of the mobile device 100 and another of the corner protrusions 420 may be configured to be flush with the height of the mobile device 100. Alternatively, all of the corner protrusions 420 may be configured to be flush with the height of the mobile device 100 or may be configured to reside below or above the height of the mobile device 100. The corner protrusions 420 may also have uniform or varying dimensions in width (best illustrated in FIG. 4) and thickness (best illustrated in FIG. 3) between the base 421 and the apex 422 of the corner protrusion 420. For example, the corner protrusions 420 may include a thickness defined between the inner and outer surfaces that varies with the height (as measured from the base 421 to the apex 422) of the protrusion 420, such as being thicker (or thinner) at the base 421 of the corner protrusion 420 as compared to the thickness closer to the apex 422 of the corner protrusion 420. By way of another example, the width, which is generally perpendicular to the thickness, may be wider (or narrower) at the base 421 of the corner protrusion 420 as compared to width near the apex 422 of the corner protrusion 420. For example, in the illustrated embodiment the thickness of the corner protrusions at the apex is 1.09 millimeters and at the base is 1.14 millimeters.

In the illustrated embodiment, the pattern of elevated interconnected walls 430 employs a repeating hexagonal external and internal shape. However, it should be understood that other shapes may be employed. For example, the pattern of elevated interconnected walls may be comprised of any pattern including any arrangement of shapes such as a square, an octagon, a pentagon, a rectangle, a triangle, a circle, a hexagon, or a heptagon, or a combination thereof. It should also be understood that the walls may be arranged in a random pattern. It should also be understood that the walls 430 may have a greater density in number or composition in one region versus another region. For example an increased or decreased density (either in composition or in number of the walls) may be employed around or near apertures.

In the illustrated embodiment, the interconnected walls 430 are oriented into hexagonal formations (or portions of a hexagonal formation) that together create a honeycomb wall pattern. The honeycomb pattern may be uniform or non-uniform. The apertures 440 in the second layer 400 and the plurality of protrusions 320 of the first layer 300 have corresponding hexagonal shapes that are dimensioned to snugly mate together, so that one, some, or all six of the hexagonal walls are in contact with one another. The pattern of elevated interconnected walls 430 may, as previously noted, be contiguous or dis-contiguous, and may or may not extend to the perimeter regions of the second layer 400, may be positioned in discrete regions, or may be spaced apart. Various patterns comprising one or more shapes may be employed alone or in combination with other patterns. The elevated pattern of interconnected walls 430 may be configured in height and construction so as to suspend the back face of the mobile device above the apertures 321 defined by one or more of the interconnected walls 430 so that the back face 120 of the mobile device 100 does not bottom out on the recessed inner surface 410 of the second layer 400.

The second layer 400 may further comprise one or more button protrusions 450 that are dimensioned and configured to extend within one or more of the control apertures 530 of the third layer 500. Each button protrusion 450 may or may not be co-molded to the corresponding control aperture 530 to form an integrated region therewith. The button protrusions are generally configured to reside above a user control button on the mobile device 100 such as a volume 132, power 152, mute, or other user buttons.

The third layer 500 may also further include one or more retention or stability tabs 550 configured to extend underneath the back face 120 of the mobile device 100. The inner surface of the tab may be in contact with the outer surface of the second layer, while the outer surface of the tab may be exposed externally. The tab 550 may be received within an aperture 350 on the first layer 300 that opens to the perimeter. The tab 550 and aperture 350 may be configured to reside closer to one end of the mobile device 100 than the other, and may be configured to reside closer to one side of the mobile device than the other.

The third layer 500 may also be configured to include retention rim 214 positioned to reside over the perimeter region 170 of the front face 110 of the mobile device 100 to assist in retaining the mobile device 100 within the case 200. The retention rim 214 may encircle a portion or the entire front face 110. For example the retention rim 214 may be configured to extend at the top, bottom, left and/or right sides (at the corners or along the sides thereof) of the mobile device in any combination thereof.

The case 200 is configured and constructed with sufficient flexibility to allow a user to install and remove the mobile device 100 within the case without damaging the case or the mobile device. The flexibility may be implemented via the construction materials employed and the configuration of the layers or components.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

While the above detailed description has shown, described, and pointed out novel features as applied to various embodiments, it will be understood that various omissions, substitutions, and changes in the form and details of the embodiments illustrated may be made without departing from the spirit of the disclosure. As will be recognized, certain embodiments of the inventions described herein may be embodied within a form that does not provide all of the features and benefits set forth herein, as some features may be used or practiced separately from others.

The previous description of the disclosed embodiments is provided to enable any person skilled in the art to make or use the invention disclosed herein. Although the various inventive aspects are disclosed in the context of certain illustrated embodiments, implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the art based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Similarly, the disclosure is not to be interpreted as reflecting an intent that any claim set forth below requires more features than are expressly recited in that claim. Rather, as the following claims reflect, inventive aspects may reside in a combination of fewer than all features of any single foregoing disclosed embodiment.

Each of the foregoing and various aspects, together with those set forth in the claims and summarized above or otherwise disclosed herein, including the figures, may be combined without limitation to form claims for a device, apparatus, system, method of manufacture, and/or method of use.

All references cited herein are hereby expressly incorporated by reference.

What is claimed is:

1. A protective case configured to reversibly receive a mobile device having a front face, a back face, a perimeter defined by top, bottom, right, and left sides residing between the front and back faces, and corners defined at the intersecting regions of the sides, said protective case comprising:
a first layer made of a first material that has a first hardness and that is dimensioned to overlie a majority of the back face of the mobile device and extend to the perimeter of the mobile device when the mobile device is fully received within the case;
a second layer made of a second material that has a second hardness and that is dimensioned to overlie a majority of the back face of the mobile device and extend to the perimeter of the mobile device when the mobile device is fully received within the case; and
a third layer made of a third material that has a third hardness and that is dimensioned to overlie at least a portion of the front face and at least a portion of each of the top, bottom, right, and left sides of the mobile device when the mobile device is fully received within the case;
wherein said first, second, and third layers are co-molded to form an integrated construction,
and wherein said first hardness is greater than said third hardness and said third hardness is greater than said second hardness.

2. The protective case of claim 1, wherein said second layer further comprises a plurality of corner protrusions positioned along the perimeter region of the second layer.

3. The protective case of claim 2, wherein said third layer further comprises indentations in its inner surface configured to engage one or more of the plurality of corner protrusions.

4. The protective case of claim 1, wherein said first inner surface further comprises a first plurality of protrusions extending in a direction away from the first outer surface.

5. The protective case of claim 4, wherein said second layer further comprises an elevated pattern of interconnected walls extending from said second inner surface a height above and in a direction away from said second outer surface, and a plurality of apertures extending into said second outer surface, wherein one or more of said apertures are in contact with and surround, at least partially, one or more of said first plurality of protrusions.

6. The protective case of claim 5, wherein said pattern of elevated interconnected walls comprises an arrangement of shapes selected from the group consisting of squares, octagons, pentagons, rectangles, triangles, circles, hexagons, and heptagons.

7. The protective case of claim 5, wherein said pattern of elevated interconnected walls comprises hexagonally oriented walls that form a honeycomb pattern.

8. The protective case of claim 7, wherein said protrusions of said first plurality of protrusions are hexagonal in shape and are dimensioned to be in contact with said hexagonal walls of said apertures.

9. A protective case configured to reversibly receive a mobile device having a front face, a back face, a perimeter defined by top, bottom, right, and left sides residing between the front and back faces, and corners defined at the intersecting regions of the sides, said protective case comprising:
a first layer having a first inner surface, a first outer surface, and a first perimeter region, said first inner surface further comprising a first plurality of protrusions positioned away from the first perimeter region and extending in a direction away from the first outer surface;
a second layer having a second inner surface, a second outer surface, and a second perimeter region, said second layer comprising a plurality of corner protrusions positioned along the second perimeter region and extending in a direction away from the second outer surface; and
a third layer having a third inner surface and a third outer surface;
wherein said first, second, and third layers are co-molded to form an integrated construction.

10. The protective case of claim 9, wherein the plurality of corner protrusions include a thickness defined between the inner and outer surfaces, and wherein said plurality of corner protrusions have a greater thickness at the base of the corner protrusions as compared to the thickness closer to the apex of the corner protrusions.

11. The protective case of claim 10, wherein the plurality of corner protrusions include a width generally perpendicular to said thickness and wherein said width is wider at the base of the plurality of corner protrusions as compared to the width near the apex of the plurality of corner protrusions.

12. The protective case of claim 9, wherein said third layer further includes indentations in its inner surface that are configured to engage one or more of the plurality of corner protrusions.

13. The protective case of claim 9, wherein said third layer includes one or more control apertures that are dimensioned and positioned to allow access to control buttons or ports on the mobile device.

14. The protective case of claim 13, wherein said second layer further comprises a button protrusion that is dimensioned and configured to extend within one or more control apertures of said third layer.

15. The protective case of claim 14, wherein the button protrusion is co-molded to the control aperture to form an integrated region therewith and is configured to reside above a volume control button on the mobile device.

16. The protective case of claim 9, wherein said third layer further includes a tab that is configured to extend underneath the back face of the mobile device, wherein the inner surface of the tab is in contact with the outer surface of the second layer and the outer surface of the tab is externally exposed.

17. The protective case of claim 16, wherein said tab is received within a perimeter aperture within said first layer that is configured to reside closer to one end of the mobile device than the other end and is configured to reside closer to one side of the mobile device than the other side.

18. The protective case of claim 9, wherein said third layer includes a retention rim configured to reside over the perimeter region of the front face of the mobile device to retain the mobile device within the case.

19. A protective case configured to reversibly receive a mobile device having a front face, a back face, a perimeter defined by top, bottom, right, and left sides residing between the front and back faces, and corners defined at the intersecting regions of the sides, said protective case comprising:
a first layer having a first inner surface and a first outer surface, wherein said first inner surface includes a first plurality of protrusions extending in a direction away from said first outer surface;
a second layer having a second inner surface and a second outer surface, wherein said second layer further comprises an elevated pattern of interconnected walls extending from said second inner surface a height above and in a direction away from said second outer surface, and a plurality of apertures extending into said second outer surface, wherein one or more of said apertures are in contact with and surround, at least partially, one or more of said first plurality of protrusions; and
a third layer having a third inner surface and a third outer surface;
wherein said first, second, and third layers are co-molded to form an integrated construction.

20. The protective case of claim 19, wherein said second layer further comprises a button protrusion that is dimensioned and configured to extend within one or more control apertures of said third layer.
